(19) United States
(12) Patent Application Publication
(10) Pub. No.: US 2008/0039012 A1
(43) Pub. Date: Feb. 14, 2008

(54) WIRELESS REPEATER WITH SIGNAL STRENGTH INDICATOR

(75) Inventors: Dave L. McKay, Duluth, GA (US); Stephen Brett Thompson, Norcross, GA (US); Donald Joseph McNeill, Sugarhill, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(73) Assignee: Andrew Corporation

(21) Appl. No.: 11/692,231

(22) Filed: Mar. 28, 2007

Related U.S. Application Data
(60) Provisional application No. 60/836,157, filed on Aug. 8, 2006.

(51) Int. Cl. H04B 7/15

(52) U.S. Cl. 455/11.1

(57) ABSTRACT

A wireless repeater includes a directional donor antenna and a display that can be used to indicate the downlink signal strength experienced by the wireless repeater. When placed in a signal strength test mode, the wireless repeater shuts down or attenuates the gain of the uplink channel to a nominal, sets the downlink gain a test value, determines the signal strength of the downlink channel, and displays an indication of the signal strength of the downlink channel. Alternatively, the wireless unit may display the downlink gain setting and the measured downlink signal strength at the same time to give the user a better understating of the operational conditions of the unit.

### REFERENCE TO RELATED APPLICATIONS

This application claims priority to U.S. Provisional Patent Application Ser. No. 60/836,157 filed Aug. 8, 2006 entitled “Wireless Repeater With Signal Strength Indicator,” which is incorporated herein by reference. This application also incorporates by reverence the commonly-owned copending U.S. patent application Ser. No. 11/127,668 entitled “Mounting Pedestal for a Cellular Signal Enhancer” filed May 13, 2005; and U.S. patent application Ser. No. 11/372,976 entitled “Remotely Controllable and Reconfigurable Wireless Repeater” filed Mar. 11, 2006.

### TECHNICAL FIELD

The present invention relates generally to wireless repeaters, which are also known as cellular signal enhancers. More particularly, the invention relates to a wireless repeater that includes a directional donor antenna and a display that can be used to indicate the downlink signal strength experienced by the wireless repeater.

### BACKGROUND OF THE INVENTION

Wireless repeaters, which are also referred to as cellular signal enhancers, serve an important function in the cellular telephone industry. They can be implemented as portable “personal repeater” units that receive, amplify and repeat bidirectional wireless telephone signals between cellular base stations and wireless telephones located in a structure, typically a home or office, where low signal strength from the base station causes degraded service or, in some cases, no service at all. The wireless repeater provides a server antenna for communicating with mobile telephones within the structure, a donor antenna for communicating with the cellular base station antenna, and a bi-directional amplifier between the server and donor antennas to boost the signal strength in both the downlink (from base station to mobile unit) and uplink (from mobile unit to base station) directions. One advantage of a portable personal repeater unit is the ability to position the unit advantageously for good donor antenna signal strength between the base station and the wireless repeater unit.

To provide a degree of antenna gain, the wireless repeater typically includes a directional donor antenna for communicating with the service provider's base station antenna. To optimize the donor antenna signal strength, it is therefore important to point the donor antenna with sufficient accuracy toward the base station antenna to result in adequate signal strength in the communication link between the unit and the base station antenna. Although precise pointing is not generally required for the unit to function properly, it is typically advantageous to at least locate the best window in a particular room for the unit. The unit can then be mounted in that window frame or placed on a piece of furniture near the window. In some locations, it may also be helpful to swivel or point the unit in the general direction of the base station antenna. Finding the best window and pointing direction, however, is not always obvious because there may not be line-of-sight visibility to the appropriate base station antenna. In addition, even if the location of the base station can be ascertained, a direct line “as the crow flies” to the base station antenna may not always be the optimal direction due to obstruction, signal bouncing or other interference conditions. Accordingly, there is an ongoing need for an easy and effective way to ascertain a preferred location for the donor signal strength of a wireless repeater.

### SUMMARY OF THE INVENTION

The present invention meets the needs described above in a wireless repeater that includes a directional donor antenna and a display used to indicate the downlink signal strength experienced by the wireless repeater. This allows the unit to be placed into a signal strength test mode so that the user can determine the downlink signal strength from the base station antenna to the wireless unit. For example, the user can carry the wireless unit around from location to location and use the signal strength indicator to identify a suitable, and hopefully best, location for the unit.

Generally described, the invention may be practiced as a wireless repeater that includes a server antenna for communicating with a mobile communication device, a directional donor antenna for communicating with a base station antenna, and a bi-directional amplifier. The wireless repeater also includes a downlink circuit operable for communicating signals from the donor antenna to the server antenna, and an uplink circuit operable for communicating signals from the server antenna to the donor antenna. The wireless repeater also includes a downlink signal strength indicator configured to indicate the downlink signal strength.

Typically, the server antenna, donor antenna, and bi-directional amplifier are disposed as a base unit within a common housing, and the unit is supported from a surface, such as a window sill, by a swivel mount that allows the unit to be pointed in different directions. This allows the user to point the wireless repeater in different directions while using the downlink signal strength indicator as a guide to find a pointing direction in which the unit experiences an acceptable level of downlink signal strength. The user can also test the downlink signal strength in different locations, such as different windows in a room, to find the best location and point direction for the unit.

Although the wireless repeater could include a dedicated signal strength indicator that shows the signal strength all the time, in one embodiment the wireless repeater is operable for selectively entering a signal strength test mode, and includes a multifunction display that displays the signal strength indicator when the wireless repeater is in the signal strength test mode. For example, the downlink signal strength indicator may be shown a visual display that represents the signal strength as one or more bars. The wireless repeater may also include adjustable downlink gain and a downlink gain indicator for indicating a level of gain applied by the downlink circuit. In particular, the downlink signal strength indicator and the downlink gain indicator may both be displayed as bar-type indicators shown in side-by-side bar relation. Showing the downlink gain and the downlink signal strength at the same time helps the user to understand how the unit is operating and, in particular, how much downlink gain has been applied by the unit to obtain the downlink signal strength that the unit is currently experiencing.

In another embodiment, the wireless repeater is configured to set the downlink gain to a test value whenever the wireless repeater is in the signal strength test mode so that the automatic gain adjustment feature does not adjust the downlink gain while the user is trying to get a measurement of the downlink signal strength. In addition, the wireless repeater may also shut down or attenuate the uplink gain to a nominal value while the wireless repeater is in the signal strength test mode to avoid feedback from the uplink circuit from infiltrating the downlink circuit during the downlink signal strength test. Of course, the wireless unit could be configured to implement these same steps during a downlink signal strength test mode in a device with a dedicated downlink signal strength indicator, a dedicated downlink gain indicator, or both. The unit could also be configured to include analogous displays and perform analogous steps for an uplink signal strength test mode.

The specific techniques and structures for implementing this invention will become apparent from the following detailed description of the embodiments and the appended drawings and claims.

### BRIEF DESCRIPTION OF THE DRAWINGS

FIG. 1 is a conceptual block diagram of a wireless repeater with a display that serves as a channel selector display and a signal strength indicator.

FIG. 2 is a perspective view of the server antenna in a wireless repeater.

FIG. 3 is a perspective view of a directional donor antenna in a wireless repeater.

FIG. 4 is a front view of a wireless repeater with a display that serves as a channel selector display and a signal strength indicator.

FIG. 5 is a front view of the wireless repeater with the display used as a signal strength display.

FIG. 6 is a conceptual illustration showing the testing of a wireless repeater in two windows to identify a preferred window with higher signal strength.

FIG. 7 is a logic flow diagram of a signal strength testing routine for a wireless repeater.

FIGS. 8A-C is a conceptual illustration of a signal strength an gain indicator.

FIG. 9 is a logic flow diagram of a signal strength and gain testing routine for a wireless repeater.

### DETAILED DESCRIPTION

This present invention may be implemented as an improvement to virtually any type of wireless repeater unit, such as the units described commonly-owned copending U.S. patent application Ser. No. 11/372,976 entitled “Remotely Controllable And Reconfigurable Wireless Repeater” filed Mar. 11, 2006, which is incorporated herein by reference. The unit may also have any suitable type of mounting system, such as the handy pedestal described in commonly-owned copending U.S. patent application Ser. No. 11/127,668 entitled “Mounting Pedestal for a Cellular Signal Enhancer” filed May 13, 2005, which is incorporated herein by reference. The mounting system described in this application allows the unit to be swiveled after installation, which facilitates pointing the unit is a desired direction in cooperation with the signal strength indicator.

More specifically, the invention may be implemented as a wireless repeater unit that can be placed into a signal strength test mode and an associated signal strength indicator that displays the downlink signal strength experienced by the unit. This signal strength indicator helps the user of the device find a location and pointing direction for the unit that produces acceptable downlink signal strength from the applicable base station antenna to the wireless unit, as indicated by the signal strength indicator. In particular, the user can test the signal strength of the downlink channel of the wireless repeater at several different windows or other locations in a desired room to find an appropriate location for the unit. Once the desired location has been identified, usually in or near a window, the wireless unit can be mounted in that location using the handy mounting pedestal described in Appendix “A” (U.S. Ser. No. 11/127,668), which allows the unit to be swiveled to a desired pointing direction using the signal strength indication as a guide.

When the wireless repeater unit is placed in the signal strength test mode, the unit typically shuts down or attenuates the gain of the uplink channel to a nominal (i.e., relatively low) value, sets the downlink gain to a test value, determines the signal strength of the downlink channel, and displays an indication of the signal strength of the downlink channel. The uplink gain is shut down or attenuated to a nominal value to isolate the downlink channel for signal strength measurement and prevent feedback from the uplink circuit from entering the downlink circuit. Isolating the downlink channel assists the user in finding the best location and direction for pointing the donor antenna toward the appropriate base station antenna.

Although other visible or audible indicators may be used, the signal strength indicator is typically shown a bar display on a multifunction display. The wireless unit may also display the downlink gain setting and the measured downlink signal strength at the same time to give the user a better understating of the operational conditions of the unit. Although the signal strength indicator may be displayed constantly or as the default display on a multifunction display, it is typically displayed temporarily on the multifunction display only when the unit has been placed in a signal strength test mode. This allows the display to be used for other purposes, such as channel selection or status indication, when the unit is not in the signal strength test mode.

It should be noted that the present invention differs from the signal strength indicator on a conventional mobile telephone unit in a number of ways. For example, a mobile telephone unit is not a wireless repeater with server and donor antennas, and a mobile telephone unit does not include a directional antenna. In addition, a mobile telephone unit and conventional wireless repeaters with signal power indicators do not shut down or attenuate the uplink gain to isolate the downlink channel for signal strength measurement, and these devices do not temporarily display the signal strength on a multifunction display only during a signal strength test mode. Moreover, a display simultaneously indicating the gain and the signal strength has not been previously included on a mobile telephone or a wireless repeater.

In one embodiment, the signal strength indicator is temporarily displayed only while the unit is in a test mode. This allows the unit to display the signal strength indicator using a multifunction display that is otherwise used for other purposes, such as configuring the wireless repeater unit and indicating the frequency channel selection of the unit. In addition, because the downlink signal strength from the base station antenna to the wireless repeater unit is typically the critical parameter to test, the unit typically disables the uplink gain to isolate the downlink signal for testing. The wireless repeater unit may also display the downlink gain setting along with the downlink signal strength in a side-by-side display to give the user a better understating of the operational conditions of the unit at a glance. Again, this display may be temporary so that the same display can be used for other purposes once the gain and signal strength conditions have been determined.

The signal strength indicator may be a number of bars as is typically used to indicate the signal strength at a mobile telephone unit. In addition, a dual signal strength and gain indicator may be displayed as two side-by-side bar displays. However, other types of signal strength and/or gain displays may be used, such as a string of LEDs, a blinking LED that blinks faster as the signal strength gets stronger, or any other suitable type of visible indication. In addition, the signal strength and/or gain displays may be, or may include, an audible display, such as beep that gets faster as the signal strength gets stronger, or any other suitable type of audible indication.

As described in U.S. Ser. No. 11/127,668, the wireless repeater unit typically comes with a mounting pedestal that allows the unit to be mounted in a window from the top or bottom window sill, and further allows the unit to swivel on the pedestal so that it can be pointed in a desired direction. This allows the user to test the signal strength at a number of locations in the desired room, typically at several windows, to select the best window and pointing direction for the unit. Once the pedestal is mounted in the desired window, the unit can be attached to the pedestal and rotated on the swivel to point the direction that produces the highest signal strength.

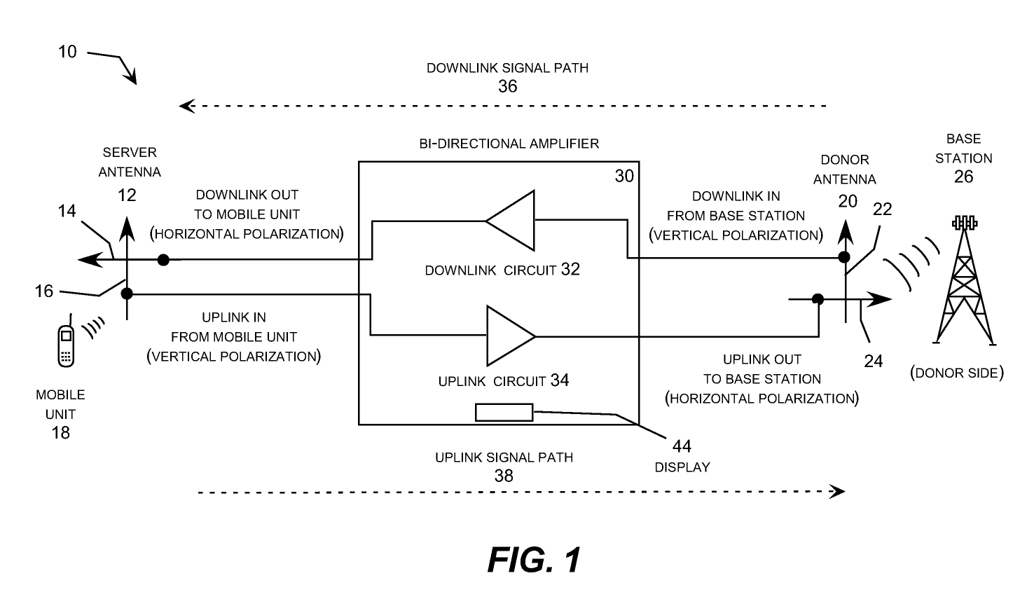

Referring now to FIG. 1, the wireless repeater 10 includes a server antenna 12 that includes a downlink portion 14 and an uplink portion 16. The server antenna 12 in this particular embodiment is a dual-polarization antenna, in which the downlink portion 14 has a different polarization state from the uplink portion 16. In this example, the polarization states are represented by arrows, which indicate that the downlink portion 14 of the server antenna has a horizontal polarization state, whereas the uplink portion 16 of the server antenna has a vertical polarization state. The server antenna 12 is designed to communicate with the customer's wireless communication device 18, also is called a mobile unit. Therefore, when the repeater is installed in a window, it should be positioned with the server antenna 12 facing into the structure.

The wireless repeater 10 also includes a donor antenna 20 that has a downlink portion 22 and an uplink portion 24. The donor antenna is designed to communicate with the base station 26 operated by or for the wireless communication service provider, which is also called the carrier. Like the server antenna, the donor antenna 20 in this particular embodiment also includes a dual-polarization antenna in which the downlink portion 22 has a different polarization state from the uplink portion 24. In this example, the downlink portion 22 of the donor antenna has a vertical polarization state, whereas the uplink portion 24 of the donor antenna has a horizontal polarization state.

The polarization scheme described above is known and “dual cross-polarization” because the server and donor antenna are both dual polarization antennas, and the system implements cross polarization both along each signal channel and across the channels. The dual cross-polarization improves the isolation of the uplink and downlink signal paths. Specifically, the downlink circuit 32 includes cross polarization along the downlink signal path from the donor downlink antenna 22 (vertical polarization) to the server downlink antenna 14 (horizontal polarization). Similarly, the uplink circuit 34 includes cross polarization along the uplink signal path from the server uplink antenna 16 (vertical polarization) and the donor uplink antenna 24 (horizontal polarization). In addition, the server antenna 12 includes cross polarization between the server downlink antenna 14 (horizontal polarization) and the server uplink antenna 16 (vertical polarization), while the donor antenna 20 includes cross polarization between the donor downlink antenna 22 (vertical polarization) and the donor uplink antenna 24 (horizontal polarization).

The wireless repeater 10 also includes and a bi-directional amplifier (BDA) 30 function that transmits and amplifies the communication signals between the server and donor antennas. More specifically, the BDA includes a downlink amplifier circuit 32 that receives communication signals from the downlink portion 22 of the donor antenna, amplifies theses signals and delivers them to the downlink portion 14 of the server antenna. Similarly, the BDA includes an uplink amplifier circuit 34 that receives communication signals from the uplink portion 16 of the server antenna, amplifies theses signals and delivers them to the uplink portion 24 of the donor antenna. Thus, the downlink signal path 36 refers to the communication path from the carrier's base station 26 to the customer's mobile unit 18, whereas the uplink signal path 38 refers to the communication path from the mobile unit to the base station. The wireless repeater 10 also includes a multifunction display 44, which can be used for a variety of purposes, such as a channel selection indicator and the display of status information to assist with configuration of the unit.

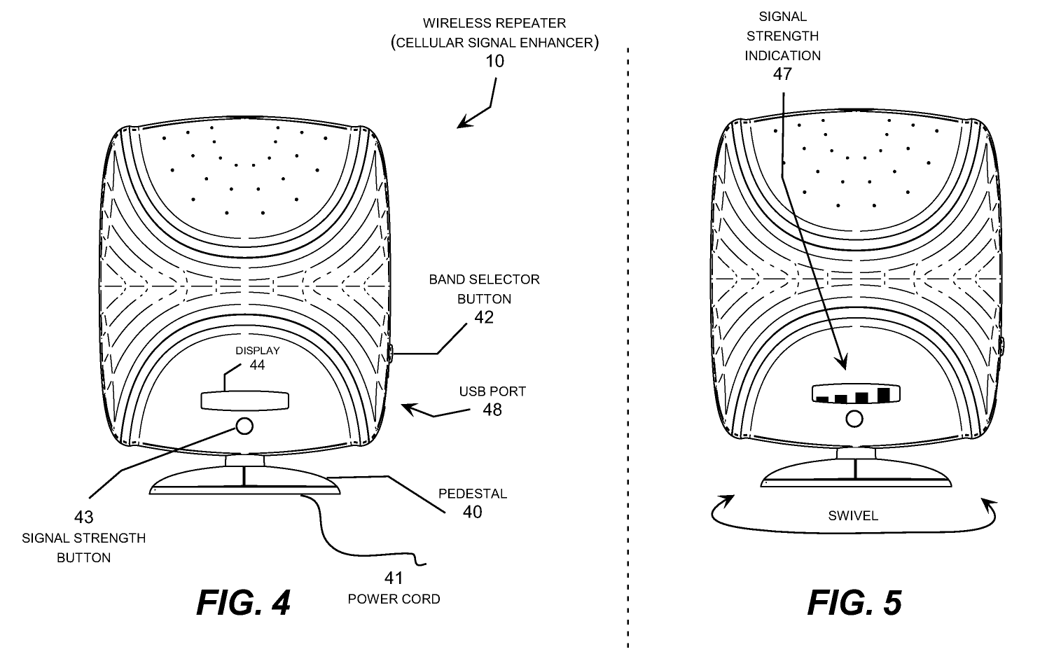

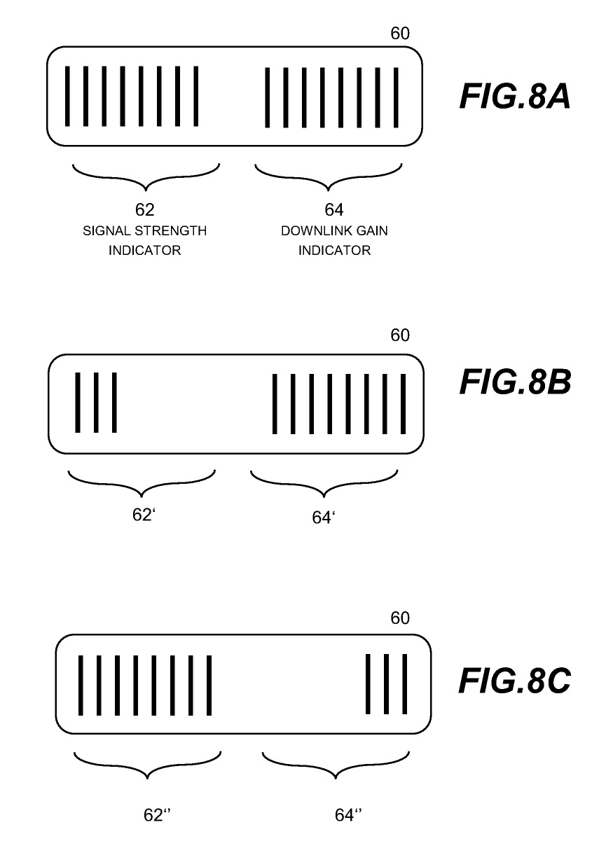

In accordance with the present invention, the multifunction display 44 serves as a signal strength indicator when the wireless repeater 10 is placed into a signal strength mode, as shown and described in greater detail below with reference to FIGS. 4-7. As an alternative, the display 44 may also serve as a combined signal strength and gain indicator, as shown and described in greater detail below with reference to FIGS. 8A-C and 9.

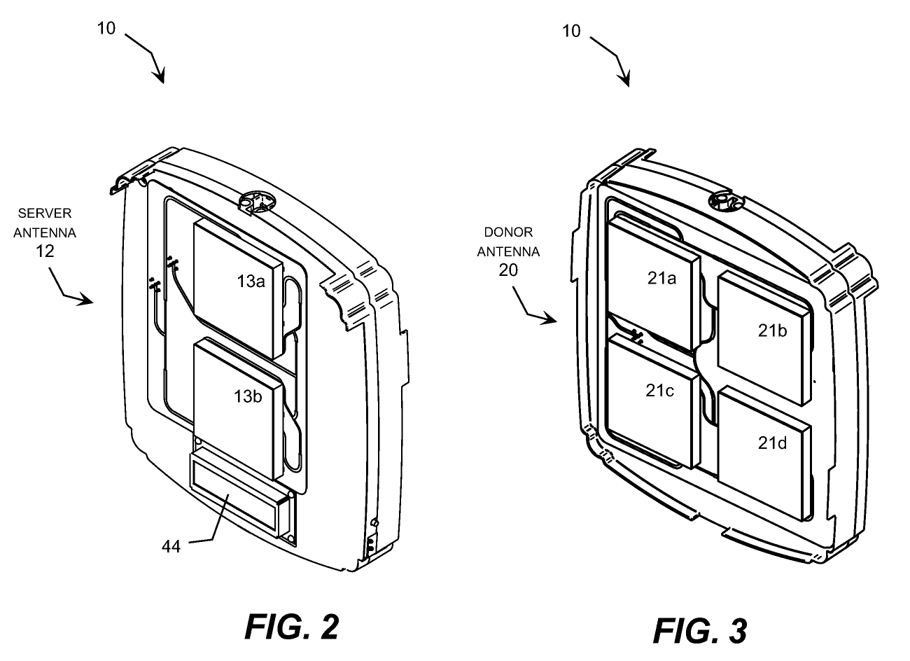

FIG. 2 is a perspective view of the server side of the wireless unit 10 with the server radome removed to show the server antenna 12. In this particular embodiment, the server antenna includes a two-element vertical array of square patch antenna elements 13a-b. This particular vertical array antenna configuration is directional in the vertical plane and non-directional in the horizontal plane, generating what is often referred to as a “horizontal fan beam” antenna pattern. It will be appreciated that this type of antenna pattern is suitable for providing communication service coverage within the interior of a room from a window location.

FIG. 3 is a perspective view of the donor side of the wireless unit 10 with the donor radome removed to show the donor antenna 20. In this particular embodiment, the donor antenna includes a four-element square array of square patch antenna elements 21a-d. This particular two-dimensional antenna array configuration is directional in both the vertical and horizontal planes, generating what is often referred to as a “cone” or “pencil beam” antenna pattern. It will be appreciated that this type of directional antenna pattern is suitable for providing significant antenna gain in a particular pointing direction. This type of antenna is therefore desirable for picking up a relatively weak base station signal in the downlink signal path, which is role of the donor antenna 20. To work optimally, however, it is important that the directional donor antenna 20 be located and positioned so that it is properly pointed in the general direction the appropriate base station.

Of course, the width of the donor antenna beam, and the corresponding antenna gain, is a function of the specific array design and a design trade off exists, with a narrower beam yielding greater antenna gain but requiring more precise pointing, whereas a wider beam yields lower antenna gain but requires less precise pointing. The particular donor antenna 20 shown in FIG. 3 is considered to be an advantageous design in view of this and other design objectives and tradeoffs inherent in the design of the wireless repeater unit, but other donor antenna configurations and alternatives may be used.

The present invention recognizes that the wireless repeater unit 10 can benefit from the use of the directional donor antenna 20 provided that the user can find a suitable location and pointing direction. Without any guidance, however, it may be difficult and potentially frustrating for the user to try to locate a good location and pointing direction for the unit. The present invention solves this problem by allowing the wireless repeater 10 to be placed into a signal strength test mode, during which the display 44 is used to indicate the signal strength of the communications signals in the downlink circuit.

More specifically, FIG. 4 is a front view of an illustrative embodiment of the wireless repeater 10. This particular wireless repeater unit includes a power cord 41 for plugging the unit into a conventional household power outlet. The unit also sits on a pedestal 40, which is described in U.S. Ser. No. 11/127,668, as noted previously. FIG. 4 also shows that the wireless repeater includes a band selection button 42, which allows the user to adjust the wireless repeater to a predetermined desired frequency channel corresponding to a desired wireless communication service provider. The unit also includes one or more communication interfaces, such as an internal wireless transmitter/receiver and a USB port 48 for connecting the unit to an external computer. These and many other features of an illustrative wireless repeater 10 are described in U.S. Ser. No. 11/372,976.

This particular embodiment of the invention makes use of the multifunction display 44, which is also be used a frequency band indicator connoting the frequency channel (and corresponding licensed carrier) that user has toggled to using the band selection button 42. In this particular model, when the wireless repeater 10 is placed into a signal test mode, the display 44 switched function to display an indication of the signal strength in the downlink circuit, such as the “four bars” signal strength indication 47 shown in FIG. 5. The wireless repeater 10 may be placed into the signal strength test mode in any suitable manner, for example by depressing a dedicated signal strength test button 43 provided on the unit. A dedicated signal strength button is not required, however, and many other mechanisms may be used to place the unit in the signal strength test mode. For example, a particular input command or sequence entered using the band selector button 42, such as holding down this button for three seconds, could be used to activate the signal strength test mode. As yet another option, the wireless repeater 10 may automatically enter the signal strength test mode upon powering on. Alternatively or additionally, a command entered into the unit through the wireless transmitter/receiver or the Universal Serial Bus (USB) port 48, or any other suitable type of communication mechanism, could also be used to place the unit in the signal strength test mode.

It should also be appreciated that the “four bars” signal strength indication 47 shown in FIG. 5 is advantageous because most users will already be familiar with this type of signal strength indicator from their mobile units. It should be further noted that the same display 44 used as the channel selector display need not be use as the signal strength display. For example, any other suitable type of signal strength display may be used, such as a string of LEDs, a blinking LED that blinks faster as the signal strength gets stronger, or any other suitable type of visible indication. Alternatively or additionally, the signal strength indicator may be or may include an audible display, such as beep that gets faster as the signal strength gets stronger, or any other suitable type of audible indication.

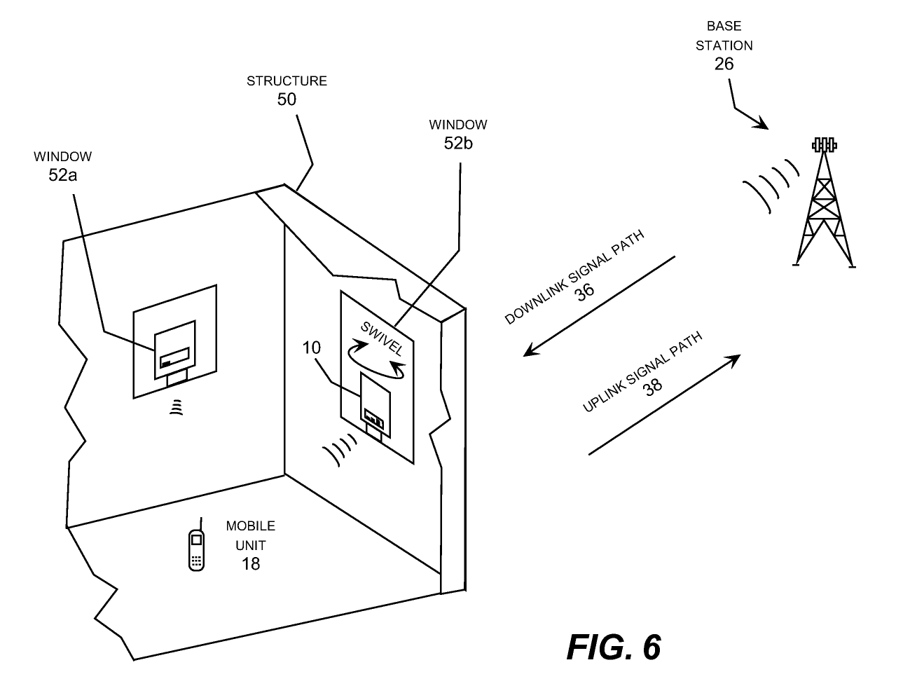

FIG. 6 is a conceptual illustration of the wireless repeater 10 in an illustrative operating environment, such as a home or business structure 50. In order to provide improved wireless telephone and data service within the structure, the wireless repeater is designed to be installed in or near a window with the donor side pointed out the window for bi-directional communication with a variety of base station antennas, represented by the base station antenna 26. The wireless repeater 10 is a self-contained, portable unit, which allows the user to place it in various locations, such as the windows 52a and 52b shown in FIG. 6. To find the preferred location for the unit, the user places in the unit in the signal strength test mode, and simply carries the unit from location to location while checking the signal strength at the available locations, typically the windows of the room. Once the desired window has been located, the user may place the unit on a piece of furniture near the window or install that wireless repeater 10 in the window frame using the pedestal as described in U.S. Ser. No. 11/127,668, and then swivels the unit to point it in a preferred direction, again as guided by the signal strength indicator.

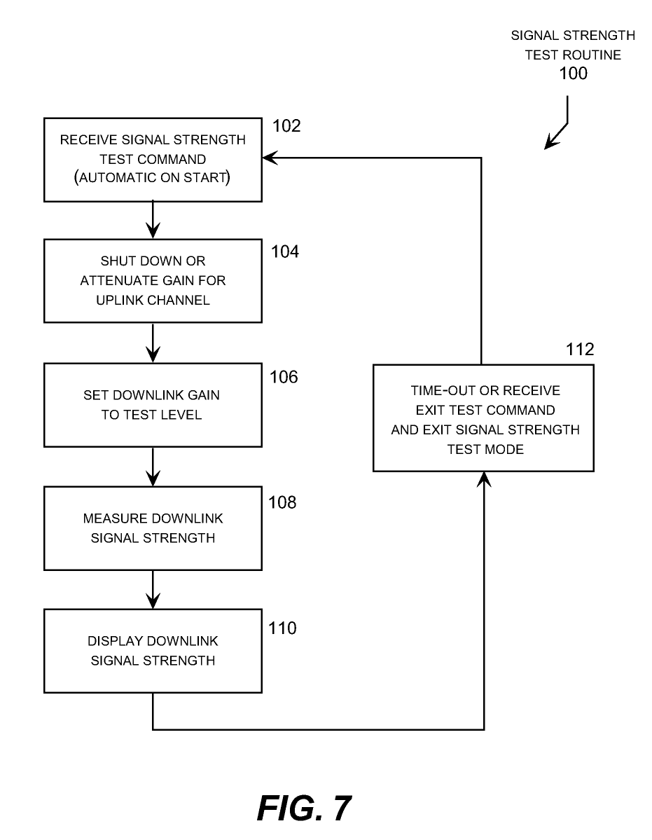

When using the signal strength test mode to locate the preferred location and pointing direction for the wireless repeater 10, it is desirable to isolate and measure the signal strength of the communication signals in the downlink signal path 38 so that the signal strength registered by the unit corresponds to the downlink signal from the base station 26 to the donor antenna of the unit without any feedback or other contribution from the uplink circuit. FIG. 7 is a logic flow diagram illustrating a signal strength test routine 100 for the signal strength test mode. In step 102, the wireless repeater unit receives a signal strength test command, typically from the signal strength button 43 or automatically upon powering on the unit. Step 102 is followed by step 104, in which the wireless repeater unit shuts down or attenuates the gain for the uplink channel to a nominal value at or near the lower end of the uplink gain adjustment range. This allows the unit to measure the signal strength in the downlink channel resulting from the communication signals received by the donor antenna from the base station antenna. Step 104 is followed by step 106, in which the wireless repeater unit sets the gain for the downlink channel to a test value typically near the center of the adjustment range. Step 106 is followed by step 108, in which the wireless repeater unit displays the downlink signal strength, for example with the well known four-bar indicator 47 on the display 44 as shown on FIG. 5. Step 110 is followed by step 112, in which the wireless repeater unit reaches a time-out or receives a command to exit the signal strength test mode, and exits the signal strength test mode. At this point, the wireless repeater discontinues the attenuation of the uplink gain, for example by returning the uplink gain to automatic gain control and/or to its pre-test level. In addition, the display 44 typically returns to another function, such as displaying the frequency channel selected for the unit.

It should be appreciated that in the signal strength test procedure described above, step 104 (set downlink gain to a test value) is an optional step. That is, the signal strength could be tested at the current gain setting of the downlink channel without resetting the gain to a nominal test value. In this case, however, the automatic gain adjustment procedure typically implemented by the unit would automatically compensate for lower signal strength at certain locations and potentially interfere with a valid comparison of the signal strength at different locations. For this reason, it is helpful to automatically set the downlink at a test level when the unit is placed in the signal strength test mode. The uplink gains is also typically shut off when the unit is in the signal strength test mode to avoid any feedback from the uplink circuit to the downlink circuit when testing signal strength of the downlink circuit. These steps normalize and isolate the downlink signal so that valid measurements of the downlink signal strength can be obtained in various locations of comparison.

Providing the user with an indication of the gain setting of the automatic gain control system at particular locations can also be an informative and helpful aid when evaluating different locations for potential location of the wireless repeater unit. In particular, a consistently fluctuating gain generally indicates intermittent signal reduction or fluctuating interference and a poor location for the unit. A consistent and stable gain level, on the other hand, is generally indicative of a good location for the unit. In addition, a high signal strength reading at a relatively moderate or low gain setting is also indicative of a good location for the unit.

FIGS. 8A-C are illustrations of a combined signal strength and gain display 60 for the wireless repeater unit. As shown in FIG. 8A in their highest indication settings, the display 60 includes an eight-bar signal strength indicator 62 and an eight-bar signal gain indicator 64. As shown in FIG. 8B, a relatively low signal strength indicator 62′ in combination with a relatively high gain indicator 64′ is characteristic of a generally poor location for the wireless unit. Conversely, as shown in FIG. 8C, a relatively high signal strength indicator 62″ in combination with a relatively low gain indicator 64″ is characteristic of a generally good location for the wireless unit. In addition, the combined signal strength and gain display 60 allows the user to monitor fluctuations in the gain and signal strength recordings to get a better understanding of how the unit is performing at different locations. Providing the unit with the combined signal strength and gain display 60 allows the signal strength to be tested at any time without causing the unit to reset the downlink gain to a predetermined test level, which could in some instances temporarily degrade the downlink signal strength sufficiently to cause the unit to lose its communication continuity or “drop the call” during the test.

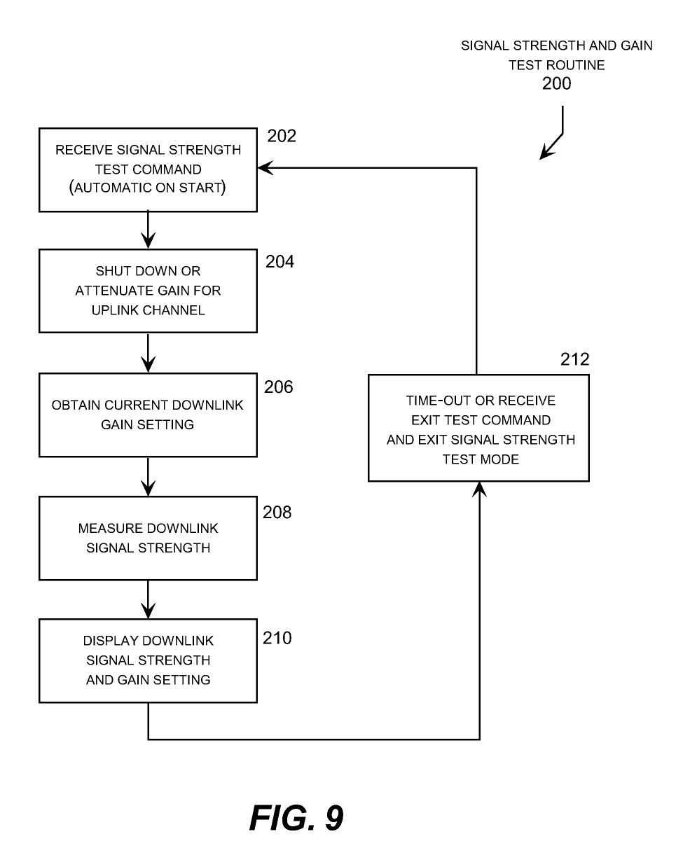

FIG. 9 is a logic flow diagram illustrating a signal strength and gain test routine 200 for use in connection with the combined signal strength and gain display 60. In step 202, the wireless repeater unit receives a signal strength test command, typically from the signal strength button 43 or automatically upon powering on the unit. Step 202 is followed by step 204, in which the wireless repeater unit shuts down or attenuates the gain for the uplink channel. Step 204 is followed by step 206, in which the wireless repeater obtains the current downlink gain setting for the unit, typically from the automatic gain control system. Step 206 is followed by step 208, in which the wireless repeater unit measures the signal strength for the downlink channel. Step 208 is followed by step 210, in which the wireless repeater unit displays the downlink signal strength, for example with the eight-bar with the signal strength indicator 62, and also displays the current downlink gain setting, for example with the eight-bar with the signal strength indicator 64, as shown in FIGS. 8A-C. Step 210 is followed by step 212, in which the wireless repeater unit reaches a time-out or receives a command to exit the signal strength and gain test mode, and exits the signal strength and gain test mode. Again at this point, the wireless repeater discontinues the attenuation of the uplink gain, for example by returning the uplink gain to automatic gain control and/or to its pre-test level, and the display 44 typically returns to another function, such as displaying the frequency channel selected for the unit.

It should be understood, however, that the unit may be configured with a setting to allow the display 44 to show the combined signal strength and gain display 60 as the default display when the unit is not otherwise directed to display a different indicator. For example, the unit could be configured to show the combined signal strength and gain display 60 as the default display, and then shift to display frequency channel selection when the user presses the channel selector button 42. In this case, the display 44 could return to the combined signal strength and gain display 60 after the unit times out or otherwise exits from the channel selection mode. A similar procedure could be used when the unit enters a configuration mode, when the display 44 may be used to show a wide range of operational settings, parameters and configuration prompts.

Of course, the wireless unit could be configured to implement these same steps during a downlink signal strength test mode in a device with a dedicated downlink signal strength indicator, a dedicated downlink gain indicator, or both. The unit could also be configured to include analogous displays and perform analogous steps for an uplink signal strength test mode. In view of the foregoing, it will be appreciated that present invention provides significant improvements in wireless repeaters. It should be understood that the foregoing relates only to the exemplary embodiments of the present invention, and that numerous changes may be made therein without departing from the spirit and scope of the invention as defined by the following claims.

The invention claimed is:

1. A wireless repeater comprising a server antenna for communicating with a mobile communication device, a directional donor antenna for communicating with a base station antenna, and a bi-directional amplifier, comprising:
a downlink circuit operable for communicating signals from the donor antenna to the server antenna having a downlink signal strength;
an uplink circuit operable for communicating signals from the server antenna to the donor antenna having an uplink signal strength; and
a downlink signal strength indicator configured to indicate the downlink signal strength.

2. The wireless repeater of claim 1, wherein the server antenna, donor antenna, and bi-directional amplifier are disposed as a base unit within a common housing, further comprising a swivel mount for supporting the base unit from a surface while allowing the wireless repeater to be pointed in different directions.

3. The wireless repeater of claim 1, wherein:
the wireless repeater is operable for selectively entering a signal strength test mode;
the wireless repeater further comprise a multifunction display that is operable for displaying the signal strength indicator when the wireless repeater is in the signal strength test mode.

4. The wireless repeater of claim 1, wherein the downlink signal strength indicator comprises a visual indication of the downlink signal strength.

5. The wireless repeater of claim 2, wherein the visual indication of the downlink signal strength comprises one or more bars on a graphical display.

6. The wireless repeater of claim 1, wherein:
the downlink circuit is configured for applying an adjustable downlink gain to communication signals transmitted from the donor antenna to the server antenna; and
the wireless repeater further comprises a downlink gain indicator for indicating a level of gain applied by the downlink circuit.

7. The wireless repeater of claim 6, wherein the wireless repeater further comprises a display operable for showing the downlink signal strength indicator and the downlink gain indicator in side-by-side relation.

8. The wireless repeater of claim 7, wherein the downlink signal strength indicator and the downlink gain indicator each comprise one or more bars.

9. The wireless repeater of claim 7, wherein:
the wireless repeater is operable for selectively entering a signal strength test mode;
the wireless repeater further comprises a multifunction display that displays the downlink signal strength indicator and the downlink gain indicator when the wireless repeater is in the signal strength test mode.

10. The wireless repeater of claim 1, wherein:
the wireless repeater is operable for selectively entering a signal strength test mode;
the wireless repeater further comprise a multifunction display that is operable for displaying the signal strength indicator when the wireless repeater is in the signal strength test mode;
the downlink circuit is configured for applying an adjustable downlink gain to communication signals transmitted from the donor antenna to the server antenna; and
the wireless repeater is configured for setting the downlink gain to a test value while the wireless repeater is in the signal strength test mode.

11. The wireless repeater of claim 1, wherein:
the wireless repeater is operable for selectively entering a signal strength test mode;
the uplink circuit is configured for applying an adjustable uplink gain to communication signals transmitted from the server antenna to the donor antenna; and
the wireless repeater is operable for shutting down the uplink circuit or attenuating the uplink gain to a nominal value while the wireless repeater is in the signal strength test mode.

12. A wireless repeater operable for selectively entering a signal strength test mode and comprising a server antenna for communicating with a mobile communication device, a directional donor antenna for communicating with a base station antenna, and a bi-directional amplifier, comprising:
a downlink circuit for communicating signals from the donor antenna to the server antenna having a downlink signal strength and configured for applying an adjustable downlink gain to the communication signals transmitted from the donor antenna to the server antenna;
an uplink circuit operable for communicating signals from the server antenna to the donor antenna having an uplink signal strength and configured for applying an adjustable uplink gain to the communication signals transmitted from the server antenna to the donor antenna; and
a multifunction display operative for displaying a downlink signal strength indicator connoting the downlink signal strength.

13. The wireless repeater of claim 12, wherein the wireless repeater is operable for selectively entering a signal strength test mode, and while the wireless repeater is in the signal strength test mode:
multifunction display is operative to display the downlink signal strength indicator;
the wireless repeater is operable for shutting down the uplink circuit or attenuating the uplink gain to a nominal value; and
the wireless repeater is operable for setting the downlink gain to a preset test value.

14. The wireless repeater of claim 12, wherein the server antenna, donor antenna, and bi-directional amplifier are disposed as a base unit within a common housing, further comprising a swivel mount for supporting the base unit from a surface while allowing the wireless repeater to be pointed in different directions.

15. The wireless repeater of claim 12, wherein the downlink signal strength indicator comprises a visual indication of the downlink signal strength.

16. The wireless repeater of claim 14, wherein the visual indication of the downlink signal strength comprises one or more bars on a graphical display.

17. A wireless repeater operable for selectively entering a signal strength test mode and comprising a server antenna for communicating with a mobile communication device, a directional donor antenna for communicating with a base station antenna, and a bi-directional amplifier, comprising:
a downlink circuit for communicating signals from the donor antenna to the server antenna having a downlink signal strength and configured for applying an adjustable downlink gain to the communication signals transmitted from the donor antenna to the server antenna;
an uplink circuit operable for communicating signals from the server antenna to the donor antenna having an uplink signal strength and configured for applying an adjustable uplink gain to the communication signals transmitted from the server antenna to the donor antenna;
a downlink signal strength indicator configured to indicate the downlink signal strength; and
a downlink gain indicator for indicating a level of gain applied by the downlink circuit.

18. The wireless repeater of claim 17, wherein the wireless repeater further comprises a display operable for showing the downlink signal strength indicator and the downlink gain indicator in side-by-side bar relation.

19. The wireless repeater of claim 18, wherein the downlink signal strength indicator and the downlink gain indicator each comprise one or more bars.

20. The wireless repeater of claim 19, wherein:
the wireless repeater is operable for selectively entering a signal strength test mode;
the wireless repeater further comprises a multifunction display that displays the downlink signal strength indicator and the downlink gain indicator when the wireless repeater is in the signal strength test mode.
